(19) United States
(12) Patent Application Publication
(10) Pub. No.: US 2025/0086291 A1
(43) Pub. Date: Mar. 13, 2025

(54) Method and system for an external cryptoprocessor to communicate with another cryptoprocessor within a computer to ensure the integrity of the computer and to provide content encryption and decryption

(71) Applicant: Ryan Anyang Yin, Los Altos, CA (US)

(72) Inventor: Ryan Anyang Yin, Los Altos, CA (US)

(21) Appl. No.: 18/462,777

(22) Filed: Sep. 7, 2023

(51) Int. Cl. G06F 21/60; G06F 21/72; G06F 21/78

(52) U.S. Cl. CPC G06F 21/602; G06F 21/72; G06F 21/78

(57) ABSTRACT

A computer uses two cryptoprocessors, an internal cryptoprocessor, and an external cryptoprocessor, which communicate to provide disk encryption. The internal cryptoprocessor contains a keypair and transmits the public key to the external cryptoprocessor. The external cryptoprocessor then generates a keypair and transmits its public key to the external cryptoprocessor. The internal cryptoprocessor encrypts content using the public key of the external cryptoprocessor. The internal cryptoprocessor may request that the external device decrypt content, which the external device then encrypts with the public key of the internal device and returns the content. The internal cryptoprocessor decrypts the content, which is now in plaintext and presentable.

### BACKGROUND OF THE INVENTION

The various aspects described herein relate to disk encryption.

Disk encryption is a technology where the contents of a disk are encrypted with a key. The key may be a keypair for an asymmetric system such as RSA or EdDSA or it may be a secret or password for a symmetric system such as AES. The key may be provided to the computer in several ways, ranging from a smart card to the entry of a password.

An attacker with physical access to a computer can replace the original computer with a look-alike which steals passwords and other keys. The attacker also steals the original computer and waits for the user to enter passwords or plug in hardware-backed keys. The attacker then uses the stolen passwords or keys to unlock the original computer, which is now under the attacker's control.

A Trusted Platform Module, even one that validates the OS perfectly cannot mitigate this attack. The attacker may simply replace the original computer, wait for the user to enter their password into the replica computer, and use the password to unlock the original computer.

Accordingly, there is a need in the art for stronger technologies which provide disk encryption.

This invention adds another layer of security through an additional cryptoprocessor which the attacker must compromise to break disk encryption.

### SUMMARY OF THE INVENTION

The machine is composed of a computer and two parts, an external cryptoprocessor which the user may carry with them, and an internal cryptoprocessor within a computer. The internal cryptoprocessor contains a public key/private key pair for an asymmetric cryptosystem. The first time the external cryptoprocessor connects to the internal cryptoprocessor, the external cryptoprocessor generates a public key and a private key, which is then tied to the public key that the internal cryptoprocessor transmitted. To provide disk encryption, the public key of the external cryptoprocessor is used to encrypt the disk. To decrypt the disk, the external cryptoprocessor first decrypts the disk using its own private key, then encrypts it with the public key of the internal cryptoprocessor. The internal cryptoprocessor then decrypts the disk with its own private key. This maintains integrity because even if the computer has been replaced with a replica, the attacker cannot decrypt the files because the attacker cannot know the private key of the internal cryptoprocessor.

### BRIEF DESCRIPTION OF DRAWINGS

FIG. 1 is a block diagram showing the components of the machine.

FIG. 2 is a block diagram showing the communications between the internal cryptoprocessor and the external cryptoprocessor during the initial connection.

FIG. 3 is a flow diagram describing how the external cryptoprocessor should handle the initial connection.

FIG. 4 is a block diagram describing the communications between the internal and external cryptoprocessors during decryption of content.

FIG. 5 is a flow diagram describing the procedure for decrypting content.

FIG. 6 is a flow diagram describing the procedure for encrypting content.

### DETAILED DESCRIPTION OF THE INVENTION

The machine is composed of a computer and two cryptoprocessors, an internal cryptoprocessor, and an external cryptoprocessor.

The computer communicates with the internal cryptoprocessor to encrypt content.

The external cryptoprocessor must be portable so the user can carry it with them. This prevents the stealing of the external device when the user's computer is stolen. The external device must implement some asymmetric cryptosystem. RSA and EdDSA are popular asymmetric cryptosystems which may be implemented. It may also be advantageous to choose a cryptosystem which is resistant to attacks by quantum computers, such as CRYSTALS-Kyber. In addition, due to the low speed of some asymmetric encryption algorithms, it may be desirable to encrypt a key for a symmetric encryption algorithm such as AES with the asymmetric algorithm, then encrypt the rest of the content with the symmetric encryption algorithm. The external device must implement decryption of encrypted content using its own private key and encryption of content using any arbitrary public key, as it is a requirement for the system.

The internal cryptoprocessor must be within the computer itself, to force an attacker to disassemble the computer and/or the device and increase the difficulty of an attack involving stealing and replacing the victim's computer. The internal cryptoprocessor must have a keypair for a cryptosystem that the external cryptoprocessor recognizes, and it must be able to encrypt files using the external device's public key in a way that the external cryptoprocessor can decrypt. It may be desirable to allow the regeneration of the keypair on the internal device, or the writing of a new keypair to the internal device. The internal cryptoprocessor may implement these functions, but they must not reveal the private key that is initially on the cryptoprocessor.

On initial connection, the internal cryptoprocessor sends the external cryptoprocessor its public key. Once the external cryptoprocessor receives the internal cryptoprocessor's public key, it generates a keypair and associates it with the internal cryptoprocessor's public key. The association must not change, unless the external cryptoprocessor receives a request signed with the internal cryptoprocessor's public key to change the key used. It is not required to implement key association changes; however, it is strongly recommended because it provides protection in the event of key compromise or other events. The external cryptoprocessor then sends the internal cryptoprocessor its public key. The internal cryptoprocessor then saves the external cryptoprocessor's public key.

Since the initial connection involves trust, it should use the most secure form of communication possible. In addition, both the internal and external cryptoprocessors should release the public keys and their associations on request. This allows the auditing of public keys to mitigate a man in the middle attack between the external cryptoprocessor and the internal cryptoprocessor.

To decrypt content, the internal cryptoprocessor sends the external cryptoprocessor the encrypted content. If the external cryptoprocessor stores multiple keypairs, it determines the proper keypair to use. If it does not, it uses its only keypair. The external cryptoprocessor then uses the private key of the keypair to decrypt the content. The external cryptoprocessor then uses the public key associated with the keypair to encrypt the decrypted content. The external cryptoprocessor then sends the encrypted content to the internal cryptoprocessor. The internal cryptoprocessor then decrypts the encrypted content using its private key and presents it to the computer. Since this entire exchange does not trust the communication medium, it may occur on any communication medium.

To encrypt content, the internal cryptoprocessor uses the saved external cryptoprocessor's public key to encrypt the content. It must not transmit content over the wire, as this would allow an attacker with physical access to listen to files' plaintext content.

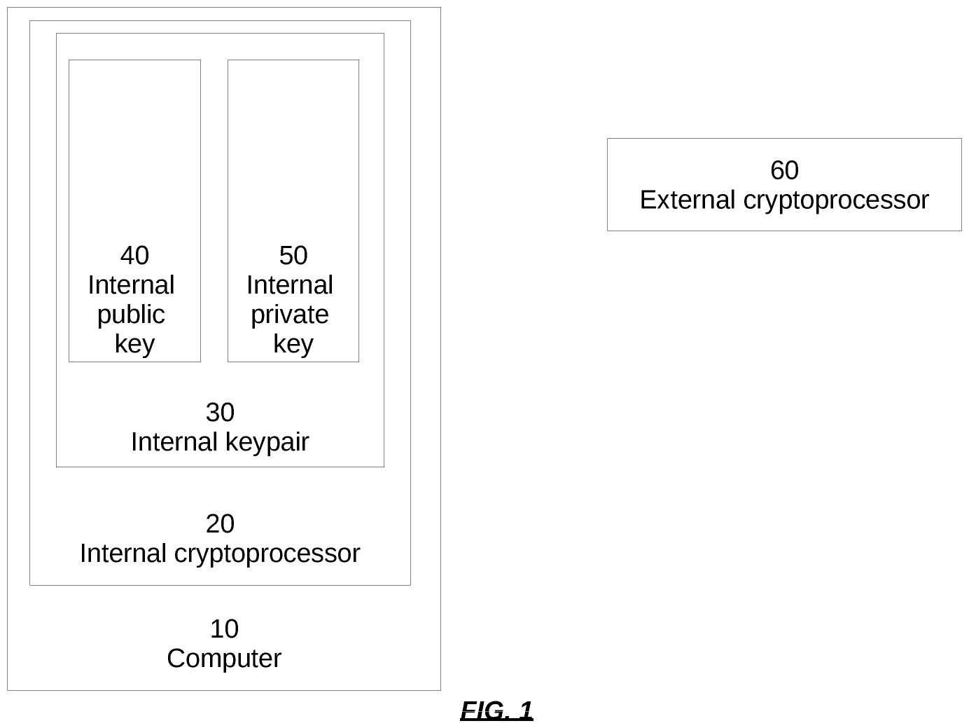

To connect these descriptions with the drawings, FIG. 1 shows a computer 10, with the internal cryptoprocessor 20. The internal cryptoprocessor has an internal keypair 30, which is composed of an internal public key 40 and an internal private key 50. The external cryptoprocessor 60 is disconnected from the computer 10, while the internal cryptoprocessor 20 is within the computer 10.

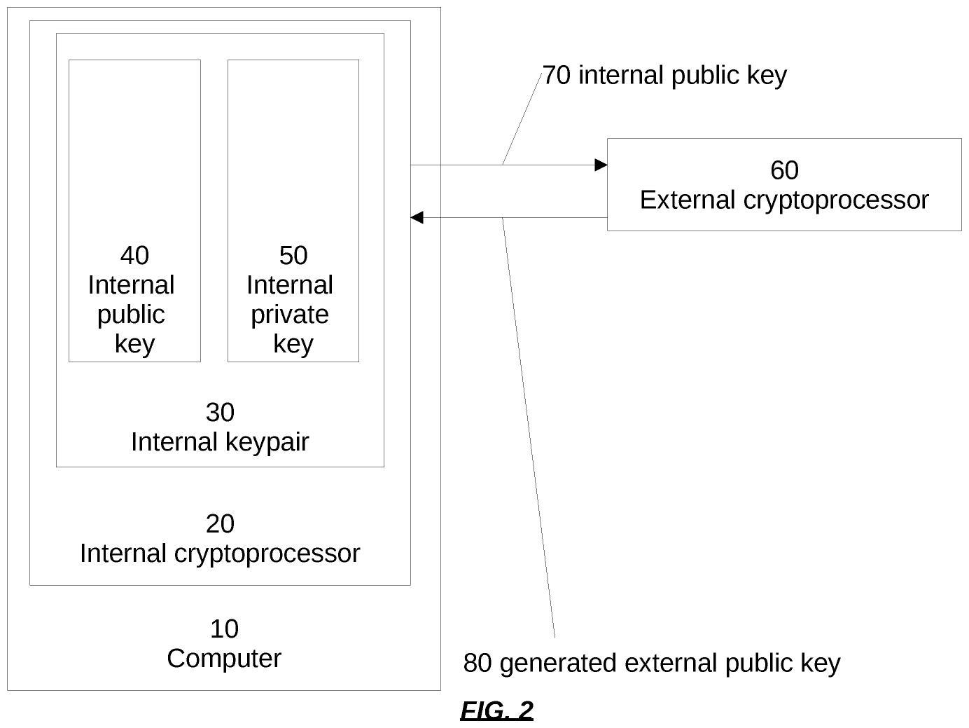

FIG. 2 describes the initial connection between the internal cryptoprocessor 20 and the external cryptoprocessor 60. The internal cryptoprocessor 20 sends 70 the external cryptoprocessor 60 its public key 40. The external cryptoprocessor 60 then responds 80 with its generated external public key.

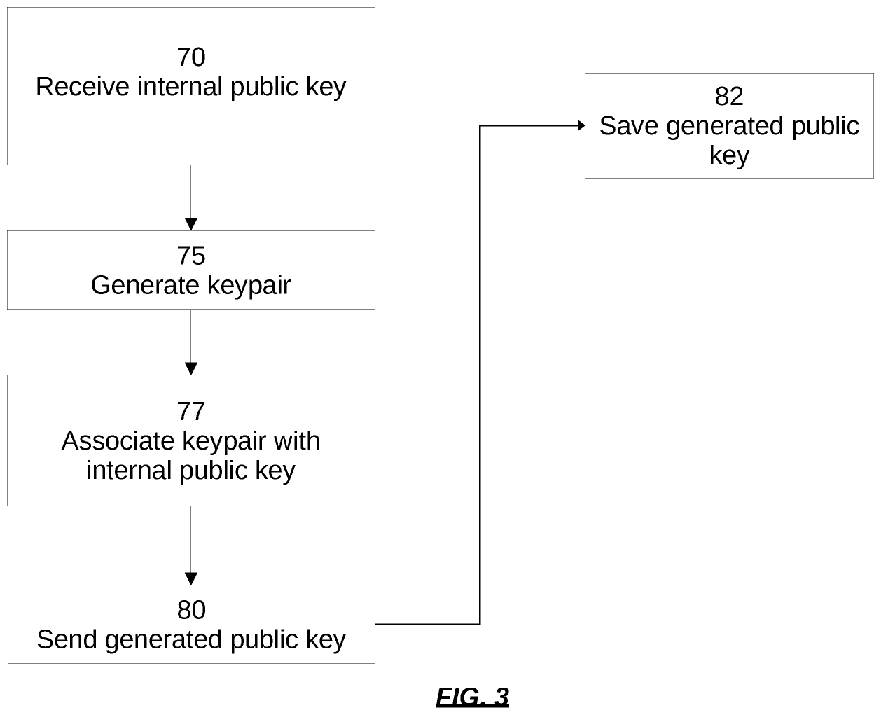

FIG. 3 describes this in terms of what each device must do during the initial connection. The external cryptoprocessor 60 receives 70 the internal public key 40. The external cryptoprocessor 60 then generates 75 a keypair. The external cryptoprocessor 60 then saves 77 the keypair used and the internal public key. If the external cryptoprocessor 60 is intended to store multiple internal public keys, it must associate the internal public key 40 with the generated keypair.

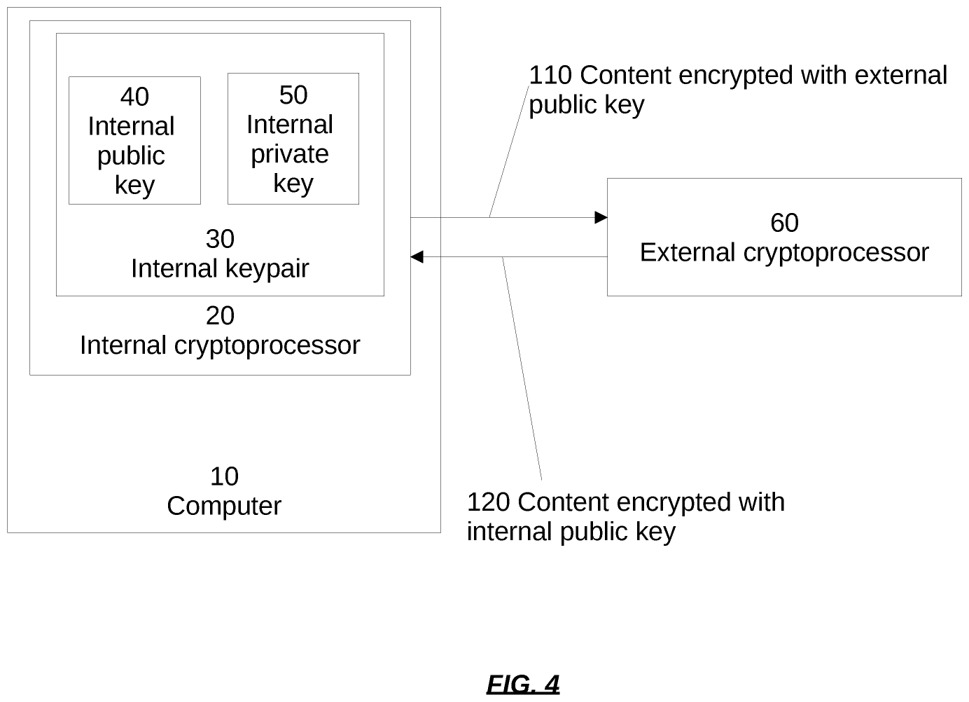

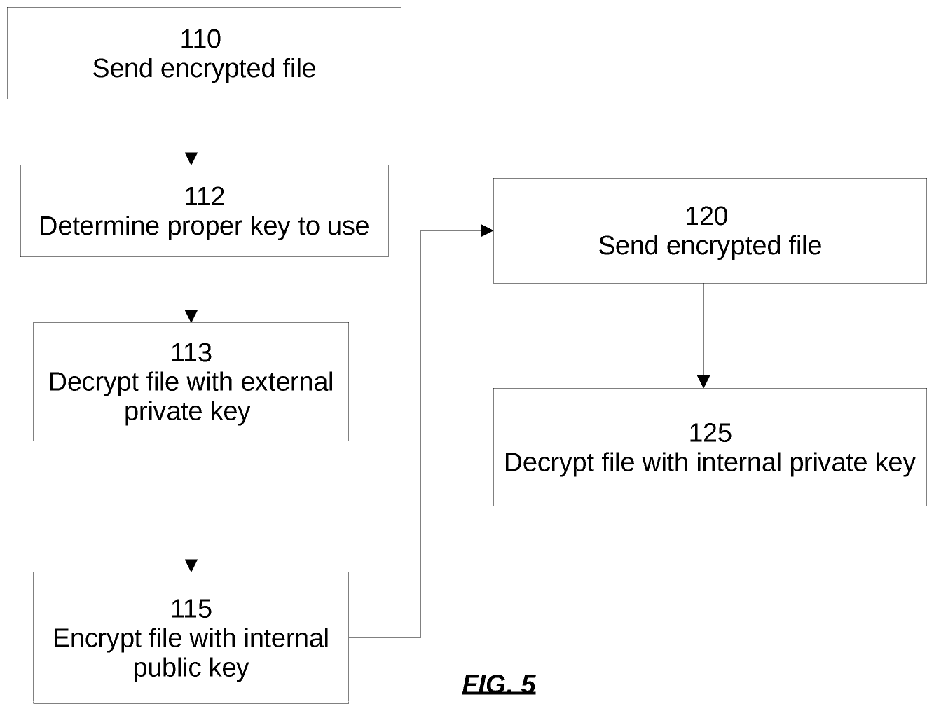

FIG. 4 and FIG. 5 describe the process for decryption. The internal cryptoprocessor 20 sends 110 content encrypted with the generated external public key to the external cryptoprocessor 60. The external cryptoprocessor 60 then determines 112 the proper private key to use. It then uses the key to decrypt 113 the encrypted content. The external cryptoprocessor 60 then uses the associated public key to encrypt 115 the decrypted content. The external cryptoprocessor 60 then sends 120 the re-encrypted content to the internal cryptoprocessor 20. The internal cryptoprocessor 20 then decrypts 125 the re-encrypted content using the internal private key 50. The internal cryptoprocessor now has decrypted content which it can present to applications on the computer 10.

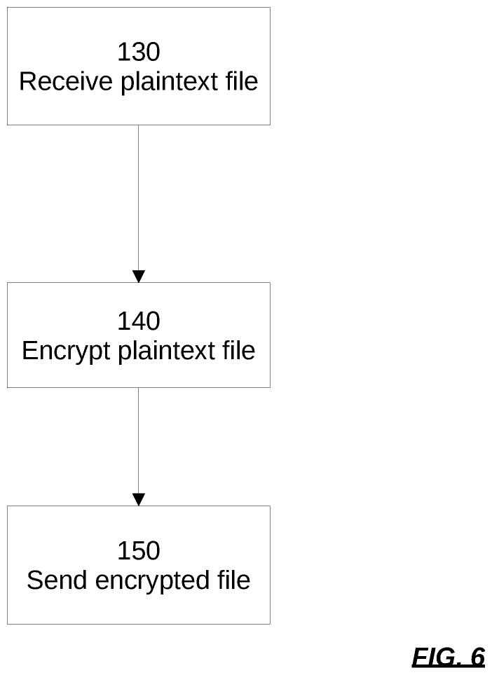

FIG. 6 describes the process for encryption. The internal cryptoprocessor 20 receives 130 plaintext content from the computer 10. The internal cryptoprocessor 20 then encrypts 140 the file using the external public key it has saved. The internal encryption 20 device then sends 150 the encrypted file to the computer 10.

1. A machine comprising of:
a. a computer;
b. an internal cryptoprocessor;
c. an external cryptoprocessor.

2. An internal cryptoprocessor as in claim 1, wherein said internal cryptoprocessor is contained within said computer.

3. An external cryptoprocessor as in claim 1, wherein said external cryptoprocessor may be carried by the user.

4. An internal cryptoprocessor as in claim 1, wherein said internal cryptoprocessor encrypts content using the generated public key of said external cryptoprocessor.

5. An external cryptoprocessor as in claim 1, wherein said external cryptoprocessor decrypts content using said external cryptoprocessor's public key and then re-encrypts content using said internal cryptoprocessor's public key.

6. A computer as in claim 1, wherein said computer uses said internal cryptoprocessor to encrypt content.

7. An internal cryptoprocessor as in claim 1, wherein said internal cryptoprocessor uses said external cryptoprocessor's public key to encrypt content.

8. A method of decryption of encrypted content, comprising:
a. internal cryptoprocessor sending the external cryptoprocessor the encrypted content;
b. the external cryptoprocessor determining the proper keypair to use, if necessary;
c. the external cryptoprocessor using the keypair to decrypt the content;
d. the external cryptoprocessor using the public key associated with the keypair to encrypt the decrypted content;
e. the external cryptoprocessor sending the internal cryptoprocessor the re-encrypted content;
f. the internal cryptoprocessor decrypting the re-encrypted content with its own keypair.

9. The method of claim 8, said encrypted content having been encrypted using said external cryptoprocessor's public key.

10. The method of claim 8, said internal cryptoprocessor being contained within a computer, said external cryptoprocessor being able to be carried by a user.

11. The method of claim 8, said keypair being generated by said external cryptoprocessor for use with said internal cryptoprocessor.
